(19) United States
(12) Patent Application Publication
(10) Pub. No.: US 2010/0019951 A1
(43) Pub. Date: Jan. 28, 2010

(54) METHOD FOR DETERMINING A VARIABLE

(76) Inventor: Ruediger Jordan, Stuttgart (DE)

Correspondence Address: KENYON & KENYON LLP, ONE BROADWAY, NEW YORK, NY, 10004, US

(21) Appl. No.: 12/096,879

(22) PCT Filed: Aug. 18, 2006
(86) PCT No.: PCT/US06/65458

§ 371 Date: Feb. 20, 2009

(30) Foreign Application Priority Data
Oct. 14, 2005 (DE) 10 2005 049 129.4

(51) Int. Cl. G01S 13/58; G01S 13/00

(52) U.S. Cl. 342/109; 342/159

(57) ABSTRACT

A method for determining a variable associated with an object, the object having a plurality of points suitable for reflecting measuring signals, a probability of reflections occurring at these points is taken into account for evaluating at least one measuring signal.

### FIELD OF THE INVENTION

The present invention relates to a method and a device for determining a variable associated with an object, and a computer program and a computer program product.

### BACKGROUND INFORMATION

A radar sensor typically measures maximum values of temporary reflections on objects. However, such reflections do not describe fixed points on the object, but instead migrate and jump as a function of the viewing angle. Even very small changes in the viewing angle are sufficient to obtain a different reflection response. For objects which are larger than the resolution capability of the radar sensor, multiple reflections may be measured at the same time. Clustering of the reflections using a fixed aperture (for example, 2 m*8 m) and averaging of measured values is a current practice. To determine a rear edge of the object, the reflection which is spatially closest is selected. This may result in apparent motions of the object when the reflection jumps on the object, or when another portion of the object returns the reflection more strongly. When traveling past a vehicle, it is also problematic when the reflection travels on an outer edge of the object toward the host vehicle. In the worst case scenario, this apparent motion of the object may result in spurious triggering of a predictive safety system (PSS).

### SUMMARY OF THE INVENTION

A method having the features described herein, a device having the features described herein, a computer program having the features described herein, and a computer program product having the features described herein are described herein.

In the method according to the present invention for determining at least one variable or state variable associated with an object, the object having a plurality of points suitable for reflecting measuring signals, a probability of reflections occurring at these points is taken into account for evaluating at least one measuring signal.

The device according to the present invention for determining at least one variable associated with an object, the object having a plurality of points which are suitable for reflecting a measuring signal. The device is designed to take into account a probability of reflections occurring at these points in order to evaluate at least one measuring signal.

Advantageous embodiments result from the description herein.

The present invention further relates to a computer program having a program code arrangement for carrying out all the steps of a method according to the present invention when the computer program is executed on a computer or an appropriate computing unit, in particular a unit in a device according to the present invention.

The exemplary embodiments and/or exemplary methods of the present invention further relates to a computer program product having a program code arrangement which is stored on a computer-readable data carrier for carrying out all the steps of a method according to the present invention when the computer program is executed on a computer or an appropriate computing unit, in particular a unit in a device according to the present invention.

The exemplary embodiments and/or exemplary methods of the present invention employs a statistical approach which takes into account the probability of points reflecting on an elongated object, for example a vehicle. Incoming measured values are weighted differently, depending on the particular probability of their occurrence at that time. In turn, this is a function of the variable, in particular a relative location or a relative speed, which is associated with the object. For this purpose, the probability of occurrence, which is deduced from a comprehensive reflection model for the object, is provided.

So-called radar reflection modeling is made possible by the present invention. Measurements of the surroundings allow a location and/or speed of an object present in the surroundings of the device to be determined. A signal is transmitted, and is reflected from a point on the object as at least one measuring signal and is received by a sensor. The device may be situated in a vehicle and used for monitoring objects in the surroundings of this vehicle.

Lastly, from all the incoming measuring signals from the object, a consolidated measured value may be formed which optimally describes the sought physical variables of the object. The consolidated measured value may be further processed in a subsequent tracking algorithm.

By use of a statistical distribution of the probability of occurrence and thus of radar reflections on the object, a location or speed determination, and therefore an estimation of the state of the object, may be carried out more accurately and reliably. Apparent motions of the object which are caused by reflection motions on the object and which thus corrupt a measurement result may be minimized by using the method.

Furthermore, motions in the longitudinal and transverse directions relative to the device may be taken into account.

Separate treatment of each variable or measurement dimension, such as distance, speed, or lateral offset of the object, may facilitate ease of operation of the model.

In the evaluation of measuring signals provided by angular resolution sensors or radar sensors, apparent motions therefore do not occur on average in the longitudinal or transverse direction when vehicles are passed; i.e., the estimated location of the object does not move along an outer edge of the object, but instead describes the center of a rear edge of the object on average.

The method may be used in predictive safety systems (PSS2) and adaptive cruise control systems (ACC plus).

Further advantages and embodiments of the invention result from the description and the accompanying drawings.

It is understood that the features mentioned above and to be described below may be used not only in the particular stated combination, but also in other combinations or alone, without departing from the scope of the exemplary embodiments and/or exemplary methods of the present invention.

The exemplary embodiments and/or exemplary methods of the present invention is schematically illustrated on the basis of one exemplary embodiment in the drawings, and is described in detail below with reference to the drawings.

### BRIEF DESCRIPTION OF THE DRAWINGS

FIG. 1 shows a diagram of a probability of occurrence used for a distance measurement.

FIG. 2 shows a diagram of a probability of occurrence used for a speed measurement.

FIG. 3 shows, in a schematic illustration, an example of an evaluation of a turntable measurement.

FIG. 4 shows a diagram of a vehicle extension model.

FIG. 5 shows a diagram of a distribution of reflections.

FIG. 6 shows a diagram of a reflection point shift.

### DETAILED DESCRIPTION

The figures are described in an interrelated and integrated manner, with use of the same reference numerals to denote identical components.

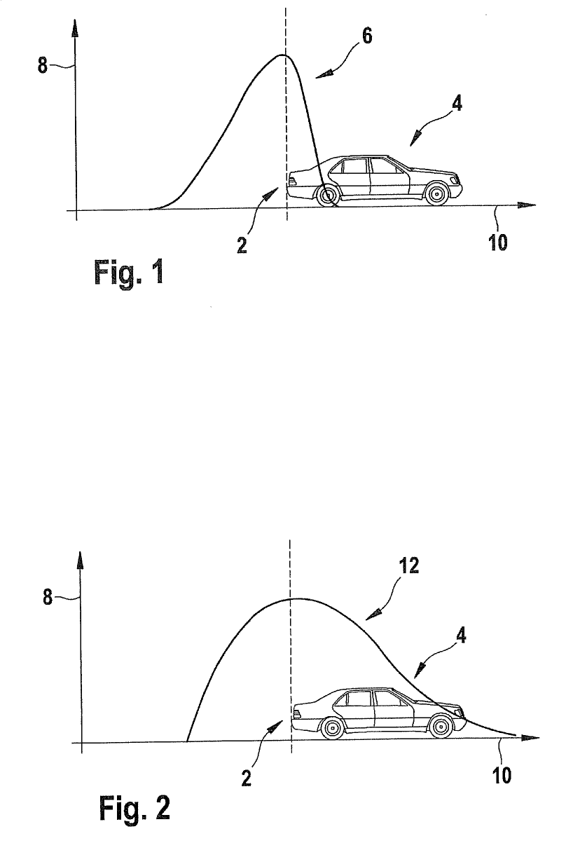

The measurement of a correct distance from a rear edge as a point 2 on an object 4, which in this case takes the form a vehicle, is based on the probability of occurrence 6 or the probability distribution of radar reflections shown in the diagram in FIG. 1, which is plotted along ordinate 8 over the abscissa 10 for the distance.

One reason for an asymmetry in the probability of occurrence 6 is that the rear edge of object 4 is not always correctly estimated. For example, when measuring objects 4 for the first time, it may happen that the front edge is measured instead of the rear edge. The probability that the actual rear edge is thus located farther backward, corresponding to a smaller distance, is higher than the probability that the actual rear edge is located farther forward, corresponding to a larger distance.

A measurement of a correct speed of object 4 is based on the probability of occurrence 12 of radar reflections shown in the diagram in FIG. 2, which is likewise plotted along ordinate 8 over abscissa 10 for the distance.

In this case, one reason for an asymmetry is that the rear edge as point 2 on object 4 is not always precisely estimated, but that any point and thus any point 2 on object 4 is able to provide a correct speed measurement. Measured values of the speed of the rear edge are generally more accurate than the measured values for points on object 4 situated farther forward, since reflections from the rear edge are more powerful.

For measuring a lateral offset of object 4, the center of the rear edge is estimated in the transverse direction of the object. However, it must be kept in mind that an accurate position of the reflection depends greatly on a viewing angle for object 4.

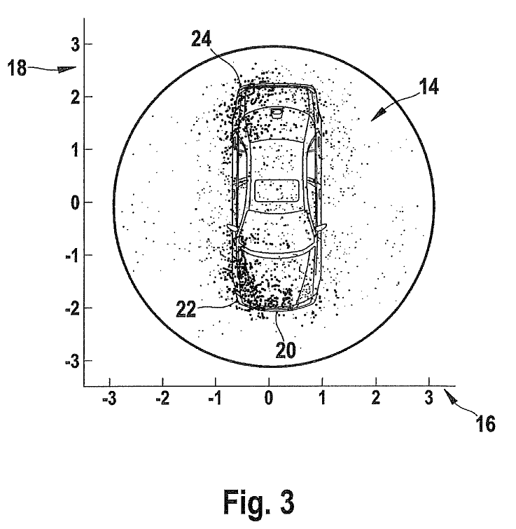

Detailed tests on objects 14, in a a vehicle schematically illustrated in FIG. 3, which are measured on a turntable in at least two spatial directions x, y 16, 18 have shown that a measured angle on average is situated at points 20, 22, 24, which are located at the smallest relative distance from a sensor. In the frontal view, a center is measured as point 20 of the vehicle. In large viewing angle ranges, only corners are measured as points 22, 24 of the vehicle. Smooth transitions result between same.

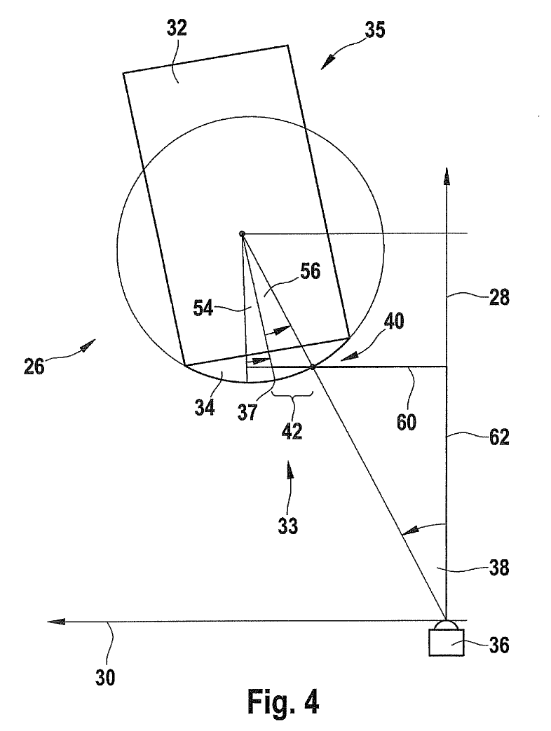

Corresponding to these findings, a dimensional model 26, shown in FIG. 4, has been developed for vehicles in first and second spatial directions x, y 28, 30. The model is composed of a rectangular body 32 having a circular curvature 34. Since in road traffic the rear edge is generally measured as point 33 on an object 35 via dimensional model 26, it is sufficient to model the latter. The objective is to estimate, from a sensor 36, center 37 of the rear edge as a function of a viewing angle φ 38. This results in a probability of occurrence of a distribution of reflections 40 at various points, which is a function of viewing angle p 38 of object 35 or the vehicle.

The relative position of object 35, as shown in FIG. 4, may be used to compute the most probable shift Δdy 42 of reflection 40 with respect to center 37 of the rear edge as point 33 of object 35.

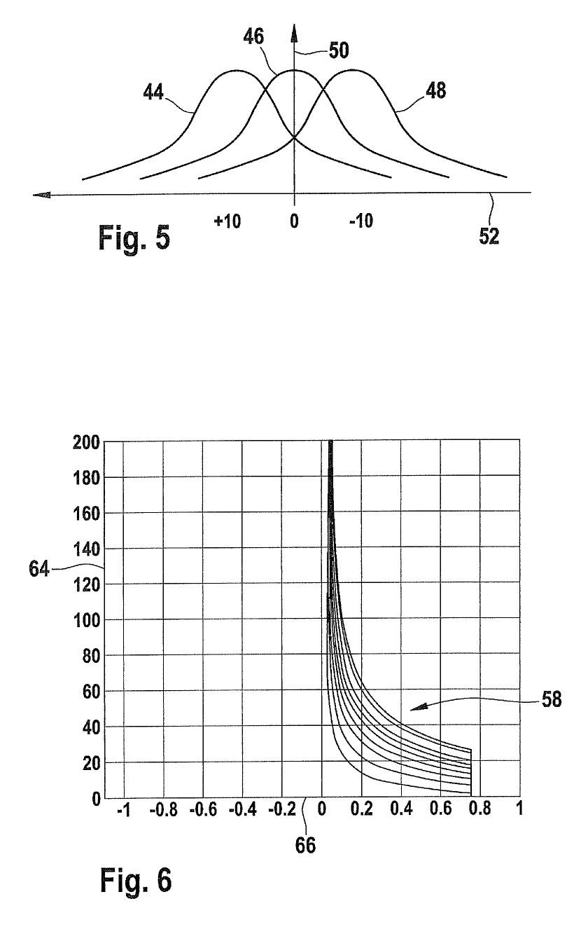

FIG. 5 shows three examples of distributions 44, 46, 48 for reflections, which are plotted along an ordinate 50 over an abscissa 52 for the viewing angle T 38 (FIG. 4).

However, an estimation of relative viewing angles 54 or 56 according to FIG. 4 represents a problem, since these variables are not directly measured by sensor or the radar sensor. However, these variables may be estimated using the relative motion in x and y directions 28, 30, via a course of the roadway or based on an instantaneous course of the observing sensor 36 itself. However, the estimate becomes more unreliable the greater the distance of sensor 36 from object 35. This must therefore be taken into account, since the estimated shift of reflections 40 is less of a factor at greater distances.

Using theoretical probability considerations, the set of curves 58 shown in the diagram in FIG. 6 is obtained for shifts of reflections 40 (FIG. 4). Each of these curves is plotted for various distances dy 60 in y direction 28 according to FIG. 4 in the direction of distances dx 62 in x direction 28 according to FIG. 4, which are plotted along an ordinate 64, over the most probable shift Δdy 42 along abscissa 66. For this purpose, as a rule, multiple viewing angles φ 38 as well as measured values for distances dx 62 and dy 60 are provided by sensor 36.

All measured values are weighted using the probability of occurrence such that the latter describes the sought physical variable. For determining a lateral offset, measuring signals that primarily also lie on the rear edge are physically provided with the most weight.

A consolidated pseudo-measured value is formed from the probability of occurrence, which describes the currently most probable speed of object 35 and the most probable position of center 37 of the rear edge of object 35. This pseudo-measured value may be further processed with the assistance of common tracking algorithms, using Kalman filters, for example.

1-11. (canceled)

12. A method for determining at least one variable associated with an object, the method comprising:
evaluating at least one measuring signal by taking into account a probability of reflections, the object having a plurality of points suitable for reflecting measuring signals to provide the reflections, occurring at the points.

13. The method of claim 12, wherein a relative location of the object is determined.

14. The method of claim 12, wherein a relative speed of the object is determined.

15. The method of claim 12, wherein the at least one measuring signal is weighted according to the probability of occurrence.

16. The method of claim 12, wherein the variable of the object to be determined is determined as a function of the probability occurrence.

17. The method of claim 12, wherein a consolidated measured value is formed from the at least one measuring signal.

18. A device for determining at least one variable associated with an object, comprising:
an evaluating arrangement to evaluate at least one measuring signal by taking into account a probability of reflections, the object having a plurality of points suitable for reflecting measuring signals to provide the reflections, occurring at the points.

19. The device of claim 18, wherein a relative location of the object is determined.

20. The device of claim 18, wherein a relative speed of the object is determined.

21. The device of claim 18, wherein the at least one measuring signal is weighted according to the probability of occurrence.

22. The device of claim 18, wherein the variable of the object to be determined is determined as a function of the probability occurrence.

23. The device of claim 18, wherein a consolidated measured value is formed from the at least one measuring signal.

24. The device of claim 18, which has a sensor for receiving the at least one measuring signal reflected by the object.

25. The device of claim 18, which has a transmitter for transmitting a signal and a sensor for receiving the at least one measuring signal reflected by the object.

26. A computer-readable medium having program code executable by a processor, comprising:
a computer code arrangement for determining at least one variable associated with an object, by evaluating at least one measuring signal by taking into account a probability of reflections, the object having a plurality of points suitable for reflecting measuring signals to provide the reflections, occurring at the points.

27. The computer-readable medium of claim 26, wherein a relative location of the object is determined.

28. The computer-readable medium of claim 26, wherein a relative speed of the object is determined.

29. The computer-readable medium of claim 26, wherein the at least one measuring signal is weighted according to the probability of occurrence.

30. The computer-readable medium of claim 26, wherein the variable of the object to be determined is determined as a function of the probability occurrence.

31. The computer-readable medium of claim 26, wherein a consolidated measured value is formed from the at least one measuring signal.
